(19) United States
(12) Patent Application Publication
(10) Pub. No.: US 2015/0075250 A1
(43) Pub. Date: Mar. 19, 2015

(54) Force Sensor Device

(71) Applicants: ETH Zurich, Zurich (CH); Ramot at Tel-Aviv University Ltd., Tel Aviv (IL)

(72) Inventors: Gabor Kosa, Modiin-Maccabim-Reut (IL); Gabor Skekely, Zurich (CH); Peter Sandor Baki, Zurich (CH)

(73) Assignee: Ramot at Tel-Aviv University Ltd., Tel Aviv (IL)

(21) Appl. No.: 14/397,006

(22) PCT Filed: Apr. 29, 2013
(86) PCT No.: PCT/EP2013/001271

§ 371 Date: Oct. 24, 2014

(30) Foreign Application Priority Data
Apr. 27, 2012 (EP) 12002987.1

(51) Int. Cl. G01L 5/16; G01L 25/00

(52) U.S. Cl. CPC G01L 5/16; G01L 5/162; G01L 5/167; G01L 25/00
USPC 73/1.15; 73/862.041; 73/862.045

(57) ABSTRACT

A force sensor device has at least three arcs distributed around a central axis. The arcs have integrated sensing elements that measure strain applied on the arc resulting from a force applied on the central axis.

### TECHNICAL FIELD

The present invention relates to a force sensor device according to the preamble of claim 1.

### PRIOR ART

Multi-axial force/torque sensors are widely used as a feedback sensor for robotic system [1], recording of contact forces [2] and biomechanical measurements [3]. Commercial and self-developed multi-axial force/torque sensors have been used in minimally invasive surgery (MIS) [4] for smart surgical instruments [5] and medical robotics (MIRS) [6].

Many sensors were realized using different sensing principles and fabrication technologies. Valdastri et al. [7] give a thorough summary of multi-axial miniaturized force sensors up to the date of the publication. Table 1 (see below) expands their collection with more recent results.

The sensors quoted in [7] and Table 1 can be classified by several criterions. One possible classification is by the sensing principle. Most of the sensors utilize piezoresistive principle by doping strain gauges in single crystal Si [7-17]. This method is convenient because the high gauge factor of the silicone (about 200-300) and the ability to implement the sensor into a micro-fabricated Si structure. There are several studies that utilize an optical sensing principle based on light intensity or interferometry [18-23]. Beyeler et al. [24] and Lee et al. [25] developed capacitive force sensors. Seibold et al. [26] developed a miniature Stewart platform and used it as a sensor.

The sensors also differ by the scale of their sensing range. The high end of the force scaling are sensors for robotics and MIRS that can sense 5-30 N [14, 18, 22, 26]. One can add to the standard sensors the commercial 6 Dof force/torque sensor of ATI Industrial Automation known as Nano-17 that's size is Ø17 mm and height is 14.5 mm. Multi axial force sensors for biomedical devices and tactile sensing have the full scale 0.5-5 N, [5, 7, 9, 11-13, 15, 19, 20, 23, 26, 27]. Several sensors alter the full scale by introducing a polymer layer between the sensing element and the contact area [15, 17, 25]. This setup can be problematic because of the reduction of the accuracy and the viscoelastic properties of the polymer interface (dependence of the measured force on the loading velocity and direction). Devices with lower sensing range limits have high accuracy and are used for measurement in micro systems and measurement of forces created by biological organisms [8, 10, 16, 17, 24, 25]. These sensors are also used in biomedical devices and estimation of 3D contact forces. The force range of such sensors is between 0.001 and 0.2 N.

One can also distinguish in Table 1 between micro fabrication technologies, e.g. MEMS [7-13, 15-17, 24, 25] and standard precision machining or electrical discharge machining (EDM) [14, 18-23, 26]. Although there is a tendency of MEMS sensors being smaller, the packaged devices do not differ much from other sensors. MEMS sensor usually can measure lower full ranges and are based on piezoresistive technologies as mentioned here before). Regularly manufactured sensors have larger full range and use mostly optical sensing.

TABLE 1
Comparisons on principal multi-component miniaturized force sensors

| | | | | No. | |
|---|---|---|---|---|---|
| | | Sensing | Fabrication | of | |
| Device | Description | Principle | Technology | axes | Size (mm) |
| Waug et al. [16] | Si structure of a column | Piezo- | SOI Micro | 3 | 4 × 4 × 20.9⁽¹⁰⁾ |
| | on 4 bridges. | Resistive | Machining | | |
| Benfield et al. | Column on a rectangular | Piezo- | Bulk Micro- | 3 | 6.5 × 6.5 × .25 |
| [8] | plate with 4 strain | Resistive | Machining | | |
| | gauges | | | | |
| Hu et al. [10] | Si structure of a column | Piezo- | Bulk Micro | 3 | 9 × 9 × .5 |
| | on circular diaphragm, | Resistive | Machining | | |
| | 2 × 2 array | | | | |
| Wen et al. [17] | 4 Si cantilevers | Piezo- | Bulk Micro | 3 | 4 × 4 × 1 |
| | embedded in PDMS, | resistive | Machining | | |
| Ho et al. [9] | Si structure of a column | Piezo- | Bulk Micro | 3 | 2 × 2 × .5 |
| | on a rectangular plate | Resistive | Machining | | |
| | supported by 4 beams | | | | |
| Vasarhelyi et al. | Si structure of 4 bridges | Piezo- | Bulk Micro | 3 | 5 × 5 × 2 |
| [15] | in an elastic substrate | resistive | Machining | | |
| Valdastri et al. | Si structure of a column | Piezo- | Bulk Micro- | 3 | 2.3 × 2.3 × 1.3 |
| [7] | on 4 bridges, | resistive | Machining | | |
| Spinner et al. | Si stricture of a column | Piezo- | Bulk Micro | 3 | 4.5 × 4.5 × 7⁽⁷⁾ |
| [13, 28] | on 4 bridges, | resistive | Machining | | |
| Kristiansen et | Si structure of a column | Piezo- | Bulk Micro | 3 | 10 × 10 × |
| al. [11] | on 4 bridges, | resistive | Machining | | 6.25⁽⁸⁾ |
| Shan et al. [12] | Column on a rectangular | Piezo- | Bulk Micro | 3 | 10 × 10 × 3 |
| | Si plate. | resistive | Machining | | |
| Tholey et al. | Strain Gauges installed | Piezo- | Integration | 3 | Ø8 × 20 |
| [14] | on the outer part of a | Resistive | with adhesives | | |
| | laparoscopic tool | | | | |
| Polygerinos et | Tube like flexible | Optical | Machining | 3 | Ø4 × 10 |
| al. [20] | structure | | | | |
| Puangmali et al. | Polycarbonate tube | Optical | Machining | 3 | Ø5 × 20 |
| [21] | structure with a rolling | | | | |
| | sphere probe | | | | |
| Peirs et al. [19] | Ti6Al4V alloy tube | Optical | Machining | 3 | Ø5 × Ø4 × |
| | | | | | 8.85 |
| Tokuno et al. | Two orthogonal frames | Optical | Machining | 2 | Ø25 × 11 |
| [23] | from PEEK450GF | | | | |
| Tan et al. [22] | Cubic Delrin structure | Optical | EDM and | 3 | 48.3 × 49.5 × |
| | made of 3 orthogonal | | machining | | 50.8 |
| | frames | | | | |
| Ohka et al. [18] | Si Rubber 10 × 12 array, | Optical | EDM mold, Si | 3 | 6 × 7.2 × .4 |
| | | | rubber casting | | |
| Beyeler et al. | Si comb drive | Capacitive | Bulk Micro | 6 | 10 × 9 × 0.5⁽³⁾ |
| [24] | | | Machining | | |
| Lee et al. [25] | 4 capacitors embedded | Capacitive | Bulk Micro- | 3 | 2 × 2 × 1.212 |
| | in PDMS | | Machining | | |
| Seibold et al. | 6 DoF Stewart Platform | Current | Precision | 6 | Ø8.4 × 3.2 |
| [26] | | generator | Engineering | | |
| | | Magnetic | | | |

| | Accuracy | F/M Range | |
|---|---|---|---|
| | (F→mN; | (F→N; | |
| Device | M→mN·m)⁽¹⁾ | M→N·m) | Characterization method |
| Waug et al. [16] | X, Y = 3E−3 | X, Y, Z = | X, Y, Z stage. |
| | | 1E−3 | |
| Benfield et al. | X, Y = 0.7, | X, Y, Z = 0.025 | Load Cell |
| [8] | Z = 2.7⁽¹²⁾ | | |
| Hu et al. [10] | X, Y = 3E−3 | X, Y, Z = | X, Y, Z stage. |
| | | 0.05 | |
| Wen et al. [17] | X = 29, Y = 20.7, | X, Y, Z = 0.2 | Force gauge palpation |
| | Z = 21 | | |
| Ho et al. [9] | F_{z} = 319, | F_{z} = 0.5(1), | X, Y, Z stage. |
| | Mₓ = 6.53E−3, | M_{x/y} = | |
| | M_{y} = 9.8E−3⁽¹¹⁾ | 0.125E−3, | |
| Vasarhelyi et al. | X, Y = 5-100, | X, Y = 0.1-2, | Specifically designed |
| [15] | Z = 12.5-250⁽⁶⁾ | Z = 0.25-5⁽⁶⁾ | setup. |
| Valdastri et al. | X, Y = 7, Z = 10 | X, Y = 0.5-0.7, | X, Y, Z test bench with to |
| [7] | | Z = 3 | NANO17 |
| Spinner et al. | Z = 0.44⁽⁷⁾ | Z = 1.16 ± 0.12 | X-Y table on a Z stage, |
| [13, 28] | | | using a vacuum chuck. |
| Kristiansen et | X, Y = 0.16, Z = | X, Y = 1, | |
| al. [11] | 0.23 | Z = 2.7 | |
| Shan et al. [12] | X = 900, Y = 914, | X, Y, Z = 2 | X-Y table on a Z stage. |
| | Z = 152⁽⁵⁾ | | |
| Tholey et al. | X, Y = 500 | X, Y, Z = 13 | Specifically designed |
| [14] | | | setup. |
| Polygerinos et | X, Y = 4, | X, Y, Z = .5 | Comparing to Nano-17 |
| al. [20] | Z = 8 | | by mounting the sensor |
| | | | on it. |
| Puangmali et al. | X, Y, Z = 20 | X, Y = 1.5, | Loading masses on the |
| [21] | | Z = 3 | sensor |
| Peirs et al. [19] | X, Y, Z = 40 | X, Y = 1.7, | Specifically designed |
| | | Z = 2.5 | setup. |
| Tokuno et al. | X, Y = 48 | X, Y = 3 | |
| [23] | | | |
| Tan et al. [22] | X, Y, Z = 140⁽¹³⁾ | X, Y, Z = 6 | 29E12A-I25 force sensor |
| | | | with MP-285 X, Y, Z |
| | | | stage. |
| Ohka et al. [18] | X, Y = 1.85, | X, Y = 10, | X-Z stage with an optical |
| | Z = 0.5⁽¹⁾ | Z = 10⁽²⁾ | setup. |
| Beyeler et al. | F_{x/y/z} = 1.4E−3, | F_{x/y/z} = 1E−3, | |
| [24] | M_{x/y/z} = 3.6E−6 | M_{x/y/z} = 2.6E−6 | |
| Lee et al. [25] | X = 0.25, | X, Y, Z = .01 | Palpation with a force |
| | Y = 0.29, Z = 0.3 | | gauge on a stage |
| Seibold et al. | F_{x/y} = 50, | F_{x/y/z} = 2.5 | Weights loaded on a |
| [26] | Fₓ = 250, | (30) | string and pulley, loaded |
| | M_{x/y/z} = ? | M_{x/y} = (300), | on the principal |
| | | M_{z} = (150)⁽⁴⁾ | directions |

⁽¹⁾X and are the in plane shear forces respectively and Z is the normal force direction
⁽²⁾Estimated from the Figures provided in the paper because in the reference the authors did not provide the data.
⁽³⁾The overall size includes a 3 mm long probe which is not essential for the function of the device..
⁽⁴⁾The values in the parenthesis are the design values, the study reports only on application of 2.5 N experimentally.
⁽⁵⁾The accuracy was calculated according to the asymmetry of the cross-talk reported by the authors.
⁽⁶⁾The data was retrieved from commercial publication of the authors spinoff company Tactologic.
⁽⁷⁾The height is determined by a 7 mm long probe pin. The resolution is estimated from the minimal displacement given in [28]
⁽⁸⁾The height is determined by a 6.25 mm long probe.
⁽¹⁰⁾The sensor has a 20.4 mm long tactile element and the sensor itself is 0.5 mm high.
⁽¹¹⁾The accuracy was calculated according to the asymmetry of the cross-talk reported by the authors.
⁽¹²⁾The accuracy was calculated according to the experimental sensitivity measurements' uncertainty.
⁽¹³⁾The accuracy was determined according to friction force F = ±0.7 N that is expressed as crosstalk in the experiments.

### SUMMARY OF THE INVENTION

It is an object of the present invention to provide a force sensor device with an increased sensitivity.

This object is achieved by the force sensor device according to claim 1.

The force sensor device comprises at least three arcs distributed around a central axis, wherein the arcs have integrated sensing elements that measure the strain applied on the arc, resulting from a force applied on the central axis. The device may comprise three, four, or more arcs.

It is a further object of the invention to provide a force sensor being able to detect acting torques as well.

This object is achieved by a device having the arcs have at least two additional integrated sensing elements that are located on a position of the arc so that a torque applied orthogonal to the central axis would cause a different strain on that second set of the additional integrated sensing elements than a force applied to the axis that would cause an identical strain as the torque on the first set of integrated sensing elements.

Preferably, at least two integrated sensing elements on any of the arcs are positioned at an angle relative to another pair of integrated sensing elements with respect to the central axis of rotation, so that a torque applied in parallel to the central axis would cause a different strain on those two integrated sensing elements than a force applied to the axis that would cause an identical strain as the torque on the other pair of integrated sensing elements around the axis, preferably with the at least two elements being the additional integrated sensing elements as described above and most preferably with them being positioned at a 45° angle relative to the first set of integrated sensing elements.

Preferably, the arcs are symmetrical with respect to the central axis and the angular spacing between the arcs with respect to the central axis is equal.

A particularly preferred embodiment comprises at least or exactly four symmetrical arcs around the central axis.

Preferably, the at least three arcs are attached to two rods or beams above and below the arcs. These rods or beams are either connected to a base or a tip of the sensor device.

The arcs, beams, tip, and base are preferably made of a monolithical structure. Most preferably, these elements form a one-piece structure.

The force sensor device or said one-piece structure is preferably made of a Ti alloy, in particular of a Ti6Al4V alloy.

The integrated sensing elements of the arcs are preferably attached to the external surface of the arcs, preferably to opposing external surfaces or to the same external surface.

Preferably, at least one, two, three, four or more of the integrated sensing elements are attached to the external surface of at least one, preferably of each of the arcs, wherein, if a plurality of integrated sensing elements is provided on one arc, said plurality of integrated sensing elements is preferably attached to opposing external surfaces or to the same external surface of the respective arc.

According to yet another preferred embodiment, the integrated sensing elements are piezoresistive or piezoelectric strain gauges, wherein preferably said gauges are provided or coated with a polymer layer for mechanical protection and electrical insulation.

The strain gauges are preferably lengthy strips with a sensitivity of measurement along the lengthwise direction of the strip.

The sensing elements may also be optical sensing elements.

In a particularly preferred embodiment, the force sensor device as described above, is a tri-axial force sensor device comprising a tip and a base, wherein said tip and said base are arranged in a spaced manner to one another along said central axis to form a gap therebetween, and wherein said gap is spanned by said arcs to connect said tip and said base to one another, wherein said arcs are bending arcs. The bending arcs are preferably arranged circumferentially with an equidistant angular spacing.

In yet another preferred embodiment, the arcs are joined in the middle of said gap such that each arc forms a double-C-shape. Hence, the sensing element is duplicated.

Preferably, a first free end of each arc extends into the first rod or beam that is connected to the tip and a second free end of each arc extends in a C-shape into the second rod or beam that is connected to the base.

In case of the double-C-shaped arcs, the arcs may be joined in the gap to form another rod or beam.

A diameter of the force sensor device, in a direction transversely to the central axis, is preferably substantially equal to or less than 3 mm. The diameter of the monolithical structure may be substantially equal to 2.6 mm. Lengths along the central axis of the tip and the arcs are substantially equal to or less than 3 mm, respectively, wherein the tip preferably has, at its free end, a rounded profile.

Preferably, each arc has a straight section, wherein two lengthy integrated sensing elements are provided on at least one, preferably on each arc. The lengthwise direction is preferably the direction of sensitivity of the integrated sensing element, i.e. the longitudinal direction C in FIG. 1. To achieve this, lengthy strain gauges may be used. Preferably said integrated sensing elements are on one and the same external surface of said straight section, wherein preferably said straight section extends parallel to the central axis and preferably has a length of substantially equal to or less than 1.5 mm or 1 mm, and wherein the two lengthy integrated sensing elements on each arc are preferably arranged in substantially crossed or angular manner with respect to one another.

The sensing elements being arranged in a crossed manner or angular manner means that the actual direction of sensitivity of the respective integrated sensing elements are crossed or at an angle to one another.

Preferably, at least two of the integrated sensing elements of the same arc are arranged on said arc, preferably on the same surface, and most preferably at a distance in direction of the central axis, wherein said distance is preferably in a range from 10% to 80% of an entire length of the arc along the central axis. Over said distance, not only two but more integrated sensing elements or groups of integrated sensing elements may be arranged. This distribution of integrated sensing elements in direction of the central axis is advantageous, as the strain profile in length direction over the respective arc may be determined, which helps in distinguishing and determining torques and forces.

Preferably, a first set of preferably two integrated sensing elements and a second set of preferably two integrated sensing elements are arranged at said c-axis distance, wherein the integrated sensing elements of the first and/or of the second set of integrated sensing elements are arranged, within the same set, in an angular manner with respect to one another, preferably substantially orthogonally to one another, wherein preferably the integrated sensing elements of the first set are arranged at an angle with the central axis of substantially 0° and 90°, respectively, and wherein preferably the integrated sensing elements of the second set are arranged at an angle of 30° to 60°, preferably of 45°, to the central axis.

Having a second set consisting of two crossed integrated sensing elements which are arranged at 30° to 60°, preferably of 45°, in both direction with respect to the surface, helps in determining a torque in Z direction (pseudo vector along the Z direction, wherein the Z direction is defined as shown in FIG. 8, 16 or 17). Having the integrated sensing elements arranged with such an angle in both directions allows being sensitive for clockwise and counterclockwise torques. Here, the first set consisting of a pair of orthogonally with respect to one another arranged integrated sensing elements, gives access to a second strain value on a different position on the arc (important for torque determination) and allows to determine acting force.

Having thus the strain profile over the arc along the central axis allows to determine the torques in X and Y direction or more general perpendicular to the central axis (i.e. pseudo vector of the torque perpendicular to the central axis), whereas having the integrated sensing elements arranged with their direction of sensitivity at an angle to the central axis allows to determine the torque in Z direction (i.e. parallel to the central axis).

Another preferred embodiment has on one or each arc two integrated sensing elements, arranged at a distance to one another along the central axis and arranged at an angle of about 90° to one another. With this embodiment, certain torques are accessible.

The integrated sensing elements are especially said lengthy strain gauges being connected through wiring, not shown in the figures, with a control unit to detect electrical signals provided by the single strain gauges through the extension, compression and bending of the arcs, on which they are mounted. The straight middle section of the C-shaped arc serves for mounting the integrated sensing elements, e.g. the gauges.

Moreover, it is an object of the present invention to use the herein proposed force sensor device for measuring a force vector in all three spatial directions.

This object is achieved by the subject-matter of claim 14. Therefore is provided a method to measure forces in three dimensions by decomposing signals from the integrated sensing elements of the force sensor device as described herein into three orthogonal elements that are directly related to the force vector applied on the connecting axis of the arcs.

A preferred embodiment of the method to measure a combination of forces into three dimensions and torques in two dimensions is decomposing signals from the integrated sensing elements of the force sensor device into three orthogonal elements of forces that are directly related to the force vector applied on the central axis and the torque vector applied orthogonal to the central axis of the arcs, whereas the torque vector is decomposed from the difference of the signals of the first pairs or set of integrated sensing elements and the corresponding second pairs or set of integrated sensing elements.

Preferred is to measure a combination of forces in three and torques in one dimension by decomposing signals from the integrated sensing elements and the additional integrated sensing elements as described above into three orthogonal elements of forces that are directly related to the force vector applied on the central axis and a torque applied parallel to the central axis of the arcs, whereas the torque is decomposed from the difference of signals of first set of integrated sensing elements and a second set of integrated sensing elements, the second set of integrated sensing elements being positioned angular with respect to the first set along the central axis of rotation.

Particularly preferred is a method to measure a combination of forces in three and torques in three dimensions by combining the methods described above.

Furthermore, a calibration device for the aforementioned force sensor device is proposed, wherein the calibration device comprises a base plate and a frame thereon, wherein said frame is rotatable about a yaw axis for setting a shear angle θ, wherein said frame is furthermore tiltable about a pitch axis for setting an angle of incidence Φ, wherein the force sensor device is positioned in a way that the yaw and pitch axes intersect one another at the base of the force sensor device, and wherein a third, translational degree of freedom is implemented by a sliding bar.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. The drawings show:

FIG. 1 Mechanical drawing (A) and 3D model (B) of the monolithic titanium force sensor device structure according to invention. The dimensions are given in [mm]. (C) shows a cross section through the tip, and (D) shows illustration of the force components applied on the force sensor device according to invention.

FIG. 2 Manufacturing steps of the sensor body: structuring the cross section (B), shaping the wings in the shear directions (C, D) and eventually removing excess material from the middle.

FIG. 3 Force sensor designs with circular (A) and ‘C’ shaped (B) basic sensing elements. The plain part of the latter structure makes it possible to assemble strain gauges on the sensor.

FIG. 4 Wheatstone bridge with the compressed (C) and tensed (T) strain gauges and the fixed value completion resistors (RC). Temperature compensation is carried out by the typically high value shunt resistor (RT).

FIG. 5 Strain Gauges on the sensor. The vertically and horizontally placed gauges form a half Wheatstone bridge. The symmetric setup ensures that the bridge has zero output in case of symmetric strain profile.

FIG. 6 FEA results of the basic sensing element. Compressive (A) and tensile (B) load at the gap causes uniform tensile and compressive stress, respectively. Shear stress (C) results in symmetric strain profile that is not detected by the half Wheatstone bridge.

FIG. 7 Block diagram of the system. The half bridges are extended on separate PCBs, the bridge outputs are connected to precision instrumentation amplifiers. The conditioned signals are converted and processed by the microcontroller. The processed data is sent to the PC via RS-232 serial port.

FIG. 8 Physical model of the measurements: the applied force is defined by its shear angle (Φ), angle of incidence (θ) and force magnitude.

FIG. 9 Calibrating mechanism presenting 3 degrees of freedom: two rotational and one translational. The red arrow corresponds to the angle of incidence (θ), the yellow to the shear angle (Φ) and the blue to the sliding movement.

FIG. 10 Bridge outputs as functions of the reference force. The manual control of the slide introduces tremor, however, the slope of the trajectories can be determined with high certainty.

FIG. 11 Output sensitivity [mV/N] versus load orientation for the four bridges.

FIG. 12 Output sensitivity [mV/N] versus load orientation function of a bridge. For better visualization the sensitivities gained from the calibration data are interconnected along the surface of the 3rd order polynomial estimation.

FIG. 13 Experimental setup with the calibrated force sensor mounted on the Nano 17. Recordings have been made while a plane metal part was pressed against the sensor in different directions.

FIG. 14 3D Force recording in time domain. The red curve represents the sensor data, whereas the blue one is the reference force.

FIG. 15 Qualitative comparison of the strain profile in case of force (A) and torque (B) shear load. The force load results in different strain distribution between the corresponding wings whereas in case of torque the wings bend in the same way.

FIG. 16 Illustration of the applied force on the sensor. a) application of two forces on one arc. Both create the same strain (red). b) the same forces applied on two arcs creates a symmetric load (F_{z} red) and an anti-symmetric load (Fₓ green). c) Relying on at least three arcs allows to measure all three force components independently.

FIG. 17 Illustration of the embodiment of the 6 DoF force/torque sensor comprising a monolithic structure made of 3 arcs with two sensing elements in addition 5 on each arc in with respect to Fig. to measure torques in addition to forces.

### DESCRIPTION OF PREFERRED EMBODIMENTS

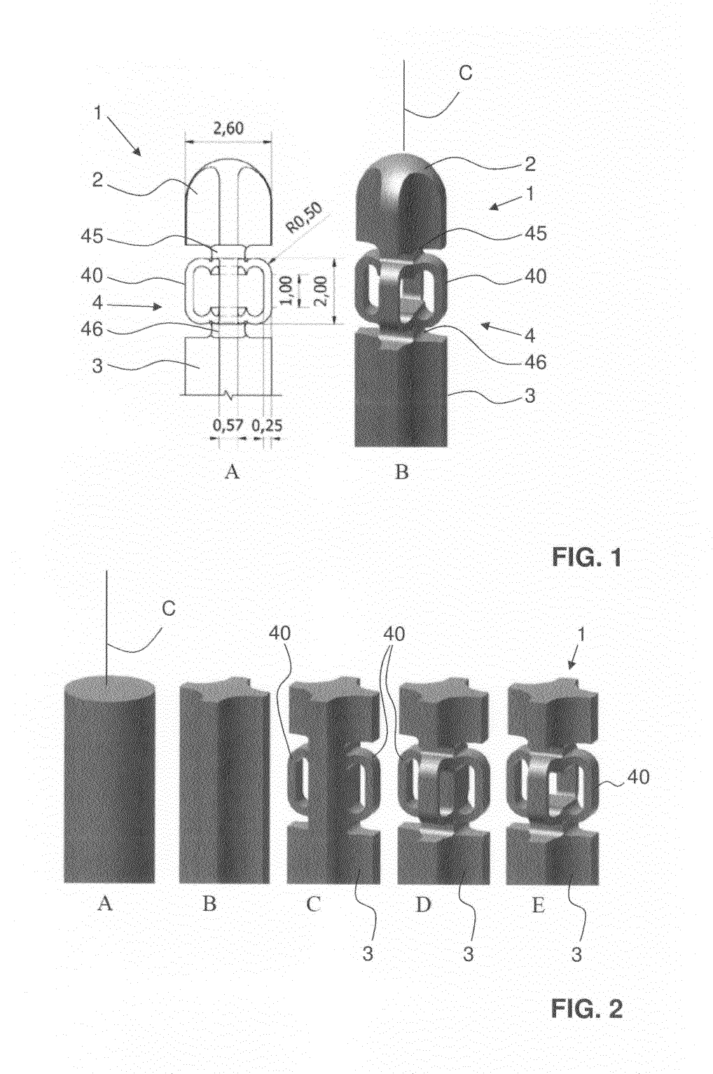

FIG. 1 shows a preferred embodiment of a tri-axial force sensor device 1 based on priezoresistive strain gauges 401, 402 (manufactured by Micron Instruments) mounted on a novel, precision machined structure comprising a tip 2, a base 4, and a sensing element 4 with four “C”-shaped arcs 40. The structures are small enough to be mounted on an MIS tool (and using them for MIRS) or catheters.

Considering the miniature size of the design we made the assumption that the torque applied on the sensor can be neglected. As the length of the lever arm is relatively short, this model is capable of characterizing the sensor.

### Sensor Design

The sensor device 1 with butterfly-shaped cross section is a new concept that enables precise 3 DoF force measurements in applications that have strict length limitations such as for catheter tips to be used in interventional radiology. Preferably, the sensor design is based on a piezoresistive principle, the sensing parts convert the applied force to mechanical strain. The solid structure consists of two inert beams or rods 45, 46 with the tip 2, the base 3, and the four bending arcs 40 interconnecting them (FIG. 1.). In order to ensure that the applied force has significant effect only on the bending arcs, the sensor device's base 3 and tip 2 are stiffer than the middle section 4. As a consequence, the sensor device's 1 size is determined by the sensing part 4, whereas the base 3 and tip 2 serve only a mounting purpose.

The outer diameter of a preferred embodiment of the force sensor device 1 is 2.6 mm, however, the structure is scalable in terms of size and force range. Unlike known devices, the sensor device 1 needs neither damping nor extra mechanical protection. In order to provide isotropic sensitivity a structure was developed that converts normal forces to bending forces instead of contraction forces. Owing to its solid metal body, the sensor device 1 is capable of enduring much higher forces than what the measurable strain range represents. Therefore, the force range is restricted by the strain sensing technology. The sensor device 1 is manufactured by the combination of conventional precision mechanical processing and electrical discharge machining (EDM) technology, due to the simple design only a couple of steps are needed to shape the structure. FIG. 2 demonstrates the fabrication steps of the metal structure.

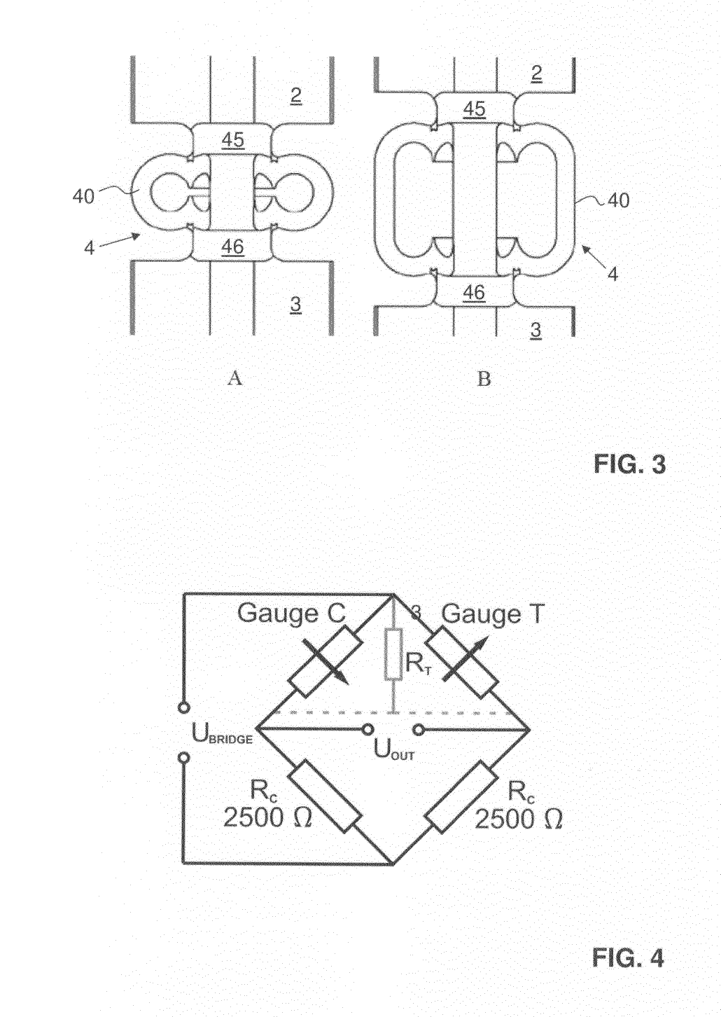

The sensing part 4 consists of four bending arcs 40 that ideally have a circular profile with discontinuity which ensures that even purely orthogonal forces result in bending. However, the used strain sensing technology requires plain surfaces as the gauges 401, 402 cannot be mounted on a high curvature surface. For this reason, each arc 40 has a 1 mm long straight section l_{sg} that serves as a base for the semiconductor strain gauges (see FIG. 3). By modifying the arcs' thickness different force range values can be set.

Micron Instruments Ltd. (California, USA) offers a wide range of strain gauges in various sizes and shapes. These devices have high gauge factor and linearity over a wide strain range and they are available in small size. A preferred embodiment comprises a SS-018-011-3000P model which has 3000±50Ω nominal resistance and gauge factor of 155±10. The thermal coefficient of the gauge factor is −0.324 1/C.°, of the resistance is 0.432 1/C.° at room temperature. As the sensor device 1 can be exposed to temperature fluctuation during in vivo interventions (e.g. RF tissue ablation) and it shows dependency on the ambient temperature, this influence needs to be taken into consideration during measurements.

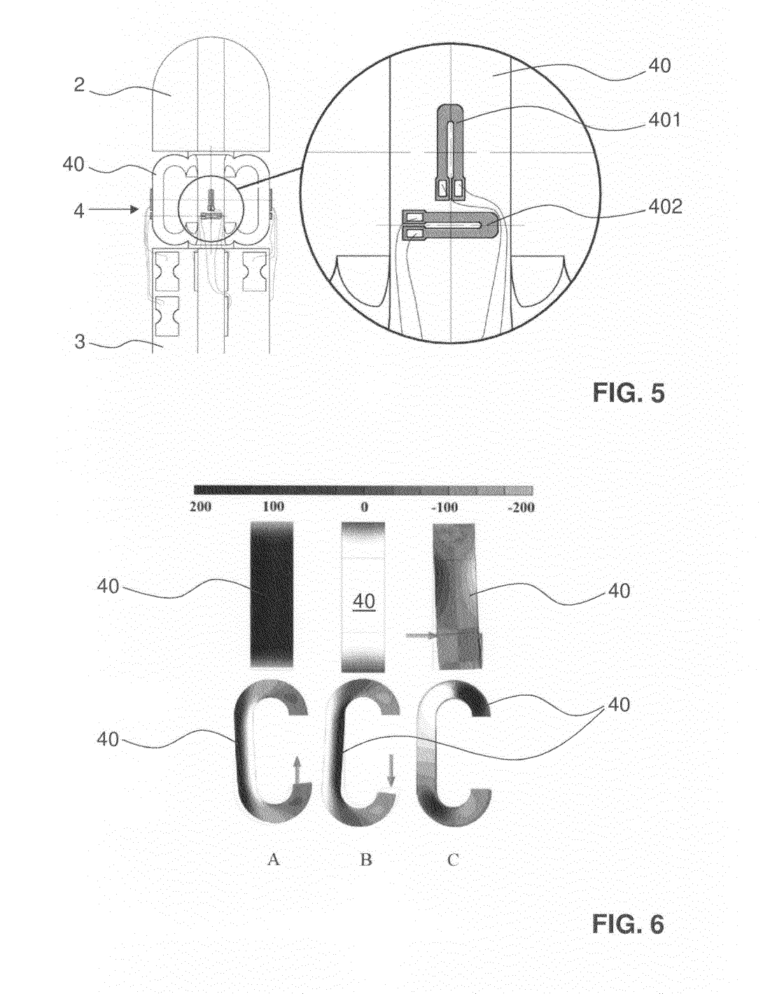

In order to minimize the influence of temperature variation Ti6Al4V alloy is advantageous for the sensor body 1 as it has a low thermal expansion coefficient, 8.6 μStrain/C.°. Furthermore, this material is biocompatible and widely used in biomedical devices. The strain gauges 401, 402 form half-Wheatstone bridges on each arc 40. In addition to the higher strain sensitivity than of the single elements, the bridge connection is associated with reduced temperature dependence. The bridges are thermally compensated by connecting typically high value resistors in parallel to either of the strain gauges, see FIG. 4. The high value of the shunt resistances ensures that they do not affect the linearity of the bridge significantly.

A half-Wheatstone bridge requires two strain gauges, one with positive and one with negative change of resistance. A common way of ensuring this is to put two gauges to the opposite sides of the bending element. One of them is compressed under load whereas the other one is tensed. For the device according to FIG. 1, assembling the gauges on an inner side of the arcs 40 would have been cumbersome to mount. Hence, it is preferred to put both gauges 401, 402 on an outer side of the arc 40, one of them is vertically oriented, the other one is horizontally. The gauging concept is shown in FIG. 5.

FIG. 6 demonstrates the FEA results of the basic sensing element, the ‘C’ shaped arc 40. Taking a closer look at the arc's strain profile one can see that the gauges 401, 402 are exposed to uneven strain distribution. In order to avoid crosstalk special attention was paid to the symmetric placement of the bridges. Therefore, in case of shear load (FIG. 6 C) the bridge output is expected to be close to zero. The measured change in resistance is proportional to the strain's average over the surface that is covered by the gauge.

Knowing the nominal resistance of the strain gauge R, the strain ΔL/L and the gauge factor GF the difference in resistance is:

$$\begin{matrix}Δ R = R * \frac{Δ L}{L} * GF , & ( 1 ) \\ Δ R = 3 k Ω * \frac{Δ L}{L} * 150. & ( 2 )\end{matrix}$$

The strain range has been chosen to be low so the bridge outputs show good linearity. Assuming perfectly matched gauges and neglecting the high value shunt resistance the relationship between the input and output voltages of the bridge is:

$$\begin{matrix}{U}_{OUT} = {U}_{BR} * ( \frac{{R}_{C}}{{R}_{C} + R - Δ R * v} - \frac{{R}_{C}}{{R}_{C} + R + Δ R} ) , & ( 3 ) \\ {U}_{OUT} = 5 V * ( \frac{2.5 k Ω}{5.5 k Ω - Δ R * 0.3} - \frac{2.5 k Ω}{5.5 k Ω + Δ R} ) , & ( 4 )\end{matrix}$$

where v is the Poisson's ratio, the relation between transverse and contraction strain. In the ±150 μStrain range the bridge output shows integral nonlinearity error of 0.625% FS.

Each half bridge needs three wires, two for the excitation and one for the output. All the bridges are driven by 5V DC voltage. The main advantage of common bridge excitation is that the number of sufficient connections reduces to 6 (2 for excitation and 4 for sensing). The cross section profile of the sensor device 1 is designed to provide enough space for the wiring. In addition to the sensor's own cabling the bites make it possible to lay wires along the sensor without contributing to its overall diameter.

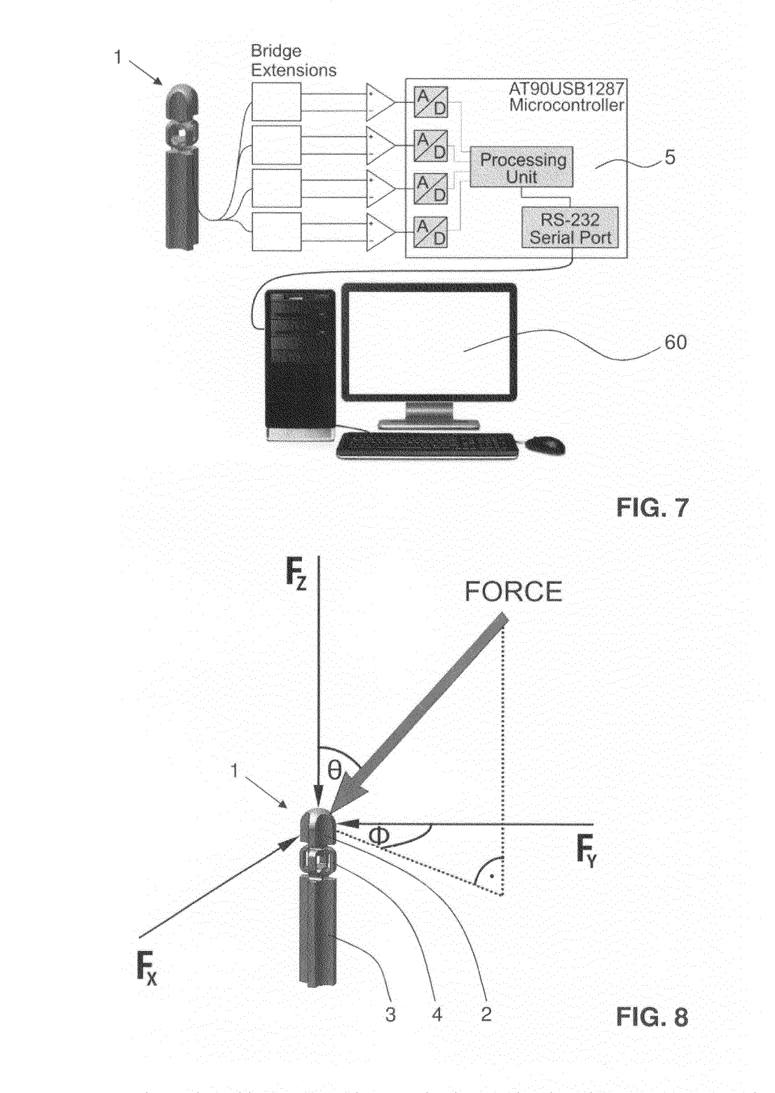

A circuit was developed that is responsible for the signal conditioning, data acquisition, and communication with the host PC 6, see FIG. 7. A piezoresistive strain gauge bridge with the parameters above produces an output voltage in the range of 40 mV, so in order to gain processable data, further signal conditioning was needed. In order to fit the dynamics of the AD channels amplification was carried out. Considering the chosen strain range (±150 μStrain), a gain of 34 has been chosen. The custom DAQ card has four input channels, the input stage of each channel is an AD8221 instrumentation amplifier with high common-mode rejection ratio and adjustable gain. No analog filter is used in the system. The amplified signal is sent to the AT90OUSB1287 (Atmel Corp., California, USA) microcontroller's integrated AD channels where the data conversion takes place at 10 bits. The acquired data is sent to the computer via RS232 serial port. The maximal obtainable refresh rate for all three channels is over 1 kHz. A LabVIEW virtual instrument is responsible for receiving, visualizing and storing the data. So far, most of the signal processing has been implemented in the LabVIEW module, however, the acquisition card is capable of executing the required operations, too. The main advantage of moving the data processing to the microcontroller unit lies in the system's flexibility. By implementing the processing locally it is possible to integrate the sensor in a control loop without the need for a computer.

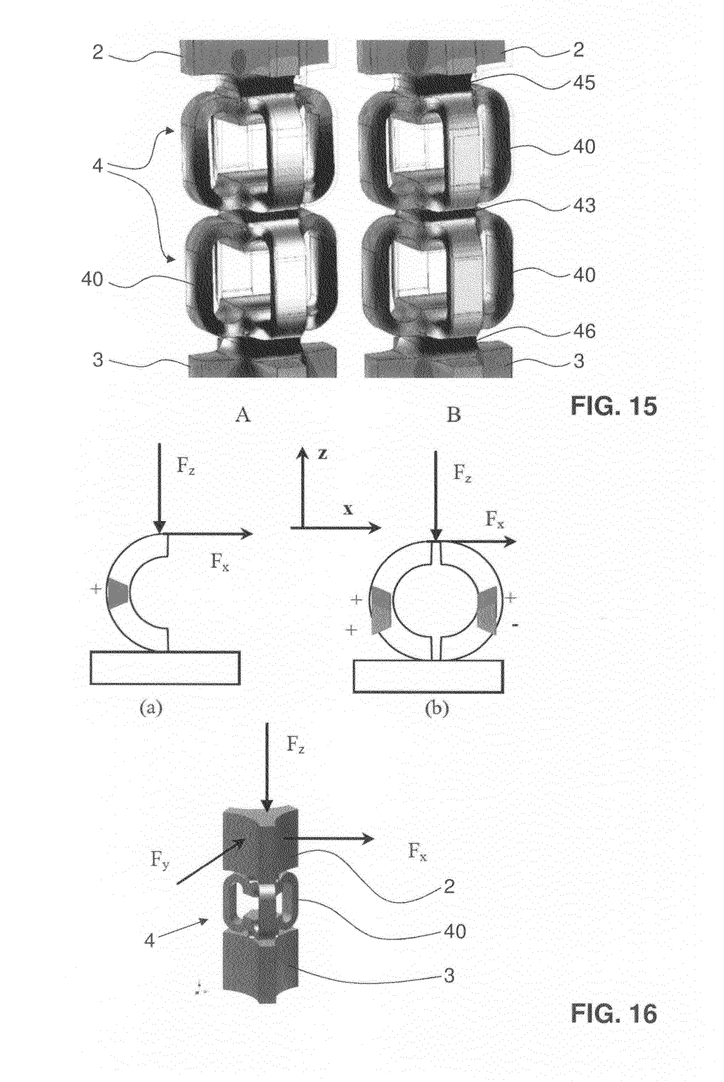

Another preferred embodiment of the force sensor device 1 comprises as a sensing block, a duplicated structure consisting of two sensor bodies, i.e. two sensing elements 4, arranged in a row along the lengthwise axis (C axis or Z axis) of the force sensor device 1, the sensing elements 4 comprising each at least three, preferably four arcs 40, This embodiment offers extended sensing capability to 5 DoF, at the cost of increased sensor length and more complicated wiring. A possible solution to extend the measurement capability of the sensor is presented in FIG. 15.

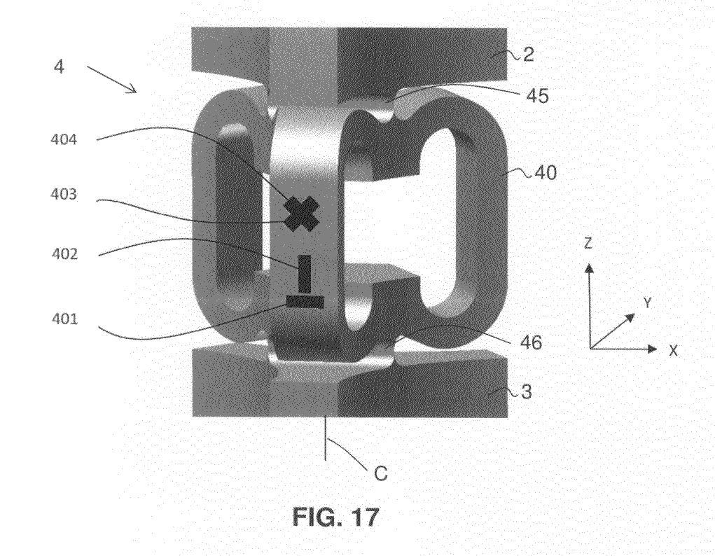

Yet another preferred embodiment of the force sensor device 1, capable of also measuring torques, is shown in FIG. 17. It provides the three arc structure 4 with two additional integrated sensing elements 403, 404 that enables sensing also the torque components in addition to force components applied on the upper part of the sensor 1. This statement is equivalent to three force components applied at a constant distance in X, Y, and Z directions. The torque components are measured by the decomposition of the bending moment into force and torque due to different locations of the integrated sensing elements 401, 402 and the additional integrated sensing elements 403, 404. It is to be understood, that also a sensing element 4 with four or more than four arcs 40 may be provided with additional integrated sensing elements 403, 404 in order to increase the number of degrees of freedom the device 1 is sensitive to.

The separation between torque and force is done as follows. Bending torques in X and Y directions create the same bending moment as forces in the Y and X directions, respectively. One can differentiate between them because the torque creates a constant strain (or curvature) in the Z direction in the arcs 40 in comparison to the force that is creating a linear strain distribution. One possible mode of decomposition is to deduct the output of the 401, 402 elements' output from the 403, 404 elements' output, whereupon the torque cancels out and the remaining part is proportional to the force. As mentioned before, due to the axis-symmetry, the analysis above is equivalent to force X, torque Y, and force Y, torque X. The decomposition of the force and torque in Z direction is different. The force in Z direction results in a symmetrical signal in all the integrated sensing elements attached to the arcs 40. On the other hand, torques in Z direction twist the structure uniformly. The symmetrical twist shear strain (due Z torque) can be separated from the symmetrical bending strain (due Z force) by placing the additional integrated sensing elements 403 and 404 in a shear strain sensitive setup, e.g. rotating them about 45° (cf. FIG. 17). The 401, 402 sensing elements will not sense the twist strain and therefore they can be used as a 3D force sensor. The 45° arrangement does not affect the strain measurement in the X, Y directions, therefore, the X, Y decomposition as described above is still valid.

The strain gauges 401, 402, 403 and 404 are all shown on the outside of one arc. They can of course be provided and attached on every arc and they are connected (although not shown) through a wiring with a control unit (not shown) adapted to detect the electrical signals generated within the strain gauges 401-404 when they are compressed, extended and bended through the movement of the arcs. Although all strain gauges are shown on the outside of the arcs 40, they can also be provided on the inner side. Especially, one of the two additional sensing elements 403 and 404 can be provided on the outside and one on the inside of the arc. This would avoid a to have a sensor with more than one layer of sensors at that crossing point.

A reference that the strain gauges are arranged at an angle of e.g. 30° to 60°, preferably of 45°, to the central axis (C) is to be understood that the angle is chosen to be between a straight line through the longitudinal axis of the respective arc being substantial parallel to C.

The width of the arcs 40 are e.g. between 0.3 and 0.8 mm and the length of strain gauge 401 as well as the effective length of gauges 403 and 404 are lesser than said width, including pads as shown in FIG. 5. Furthermore, FIG. 5 shows wiring for read out of the gauges, being connected to a central control unit 5 as shown in FIG. 7.

The material thickness perpendicular to the central axis C is especially between 0.1 to 0.4 mm, in particular 0.25 mm, especially approx. ¼ of the essentially straight length section of the arc 40. FIG. 1 shows an isometric view of a preferred embodiment of the force sensor device 1.

### Calibration Model

In order to determine the correspondence between the raw bridge signals and the force vector we needed a coherent force model. The 3D force data can be characterized either by three Cartesian force components (Fₓ, F_{y} and F_{z}) or by the magnitude and exact orientation of the load force. In our model the sensor base is regarded fixed and the force is applied radially on the rounded profile tip 1. The shear angle and angle of incidence combination unequivocally determines the orientation of the load.

The aim of the calibration is to find a linear matrix transform C between the strain gauge bridge signals B=[B₁, B₂, B₃, B₄]^{T} and the three-component force vector F=[F_{X}, F_{Y}, F_{Z}]^{T} applied to the sensor:

F=C*B, (5)

The transform matrix can be determined by evaluating the Moore-Penrose least-squares error solution to the over determined set of equations. 25 calibration force vectors have been used as reference data for the calculations. The sensitivity of the bridges in a given direction was originated from the force-bridge output trajectories. Three independent degrees of freedom have been selected in order to make measurements in arbitrary directions: the shear angle Φ, the angle of incidence θ and the translation in radial direction F. This way, in a given solid angle domain, any shear angle-angle of incidence combination [θ, Φ] can be set up. After making recordings from defined directions one can find the relationship between the sensor device's recorded data and the given angular setup.

### Calibration Mechanics

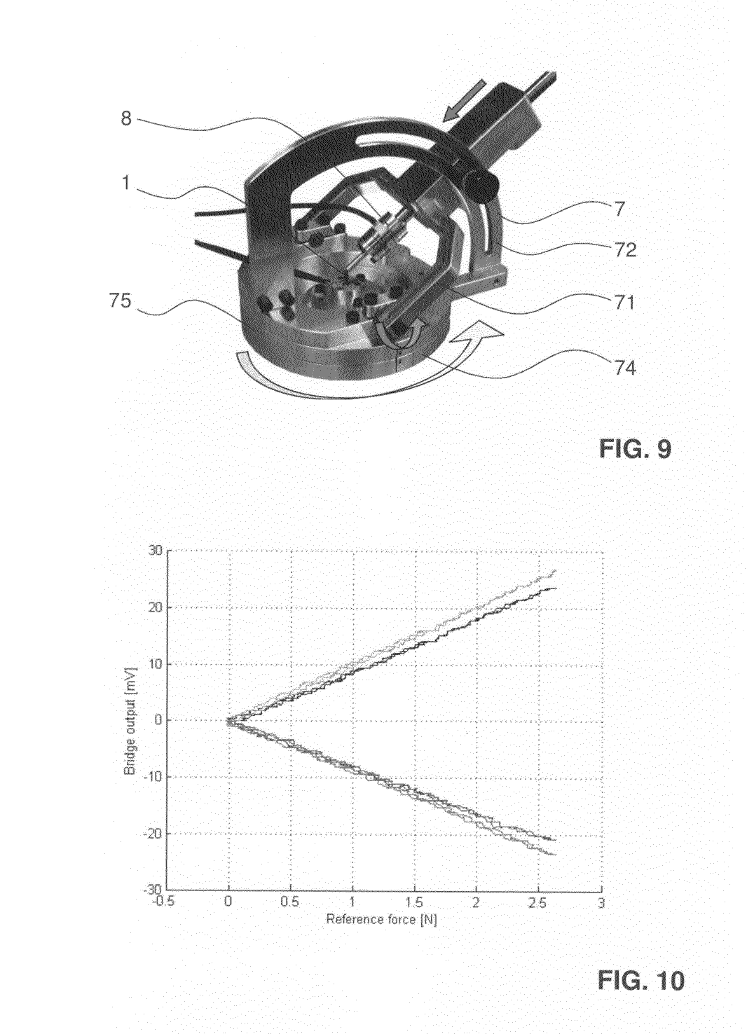

A calibrating setup 7 has been developed so that the necessary measurements can be taken in a repeatable and precise manner, see FIG. 9. The structure is preferably made of aluminum in order to provide a rigid structure that can serve as a frame 71 for the related experiments. It has been designed in order to improve the reliability and repeatability of the measurements, and to determine the actual force vector in arbitrarily set directions.

One rotational degree of freedom is implemented around the yaw axis. By rotating the frame 71 on the base plate 75 the shear angle θ can be set to the desired value. The angle of incidence Φ is adjustable by tilting the fork element or frame 71. The sensor device 1 is positioned in a way that the calibration structure's yaw and pitch axes intersect each other at the base of the sensor device 1. Therefore, radial direction in the calibration design's coordinate system means radial direction in case of the sensor device 1 as well. The third, translational degree of freedom is implemented by a sliding bar 72. The aim is to collect force data by a reference sensor that can be used for the calibration. An ATI Nano17 (ATI Industrial Automation, Inc., NC, USA) 6 DoF force sensor 8 has been assembled on the tip of the bar. In order to provide better access to the sensor 8 an additional poking tip was mounted on the Nano 17. The main axes of the sliding bar 72, the reference sensor 8 and the tip are concentric. It is important to emphasize that even though the Nano 17 is capable of 6 DoF measurements, it was an interest to determine the force component in its normal direction. Owing to the constraints introduced by the calibration mechanics, the normal force component of the reference sensor 8 is identical to the absolute force that is applied on our sensor's tip 2. In accordance with the sensor model described herein that does not take the moments into account, the calibration mechanics make sure that no torques occur thanks to the proper constraints.

### Calibration Results

Experimental characterization has proven the ability of the sensor device 1 to measure the force vector. The output voltage response of the sensor device 1 was compared to the data of the reference force sensor 8. Measurements have been made in 25 directions in order to obtain reliable data for the calibration process. The angle of incidence ranged from 0° to 90° in 30° steps whereas the shear angle varied from 0° to 360° in 45° steps, covering a whole half-space. In each direction the force was exerted by means of pressing the sliding bar 72 with the Nano 17 and the poking tip against the force sensor device 1. As the recorded data of the ATI reference sensor 8 and the force sensor device 1 were synchronized in time, one could evaluate the relationship between the bridge outputs and the known force. Since this calibration setup has no linear actuator the load was applied manually. Each measurement cycle consisted of developing and releasing the load. The loading force range was selected to fit the sensitivity of the sensor 1 considering the simulation results. Even though the calibration structure 7 ensured that in a given orientation the only degree of freedom is translation of the sliding bar 72, the manual guidance of the bar introduced slight wobble. Certainly the human controlled loading resulted in non-constant translational speed. However, experimental data showed that this method provides sufficient accuracy. The bridge output versus loading force trajectories were investigated in order to evaluate the hysteresis and the linearity of the sensor device 1. The slope of the curves, that has been extracted using linear regression, represents the sensitivity in a given direction. The coefficient of determination was found to be close to one for all the cases so the trajectories showed high linearity. FIG. 10 demonstrates the absence of hysteresis. The loading experiment was repeated 10 times in the normal direction in order to verify the repeatability of the sensor. No significant deviation was identified among the samples.

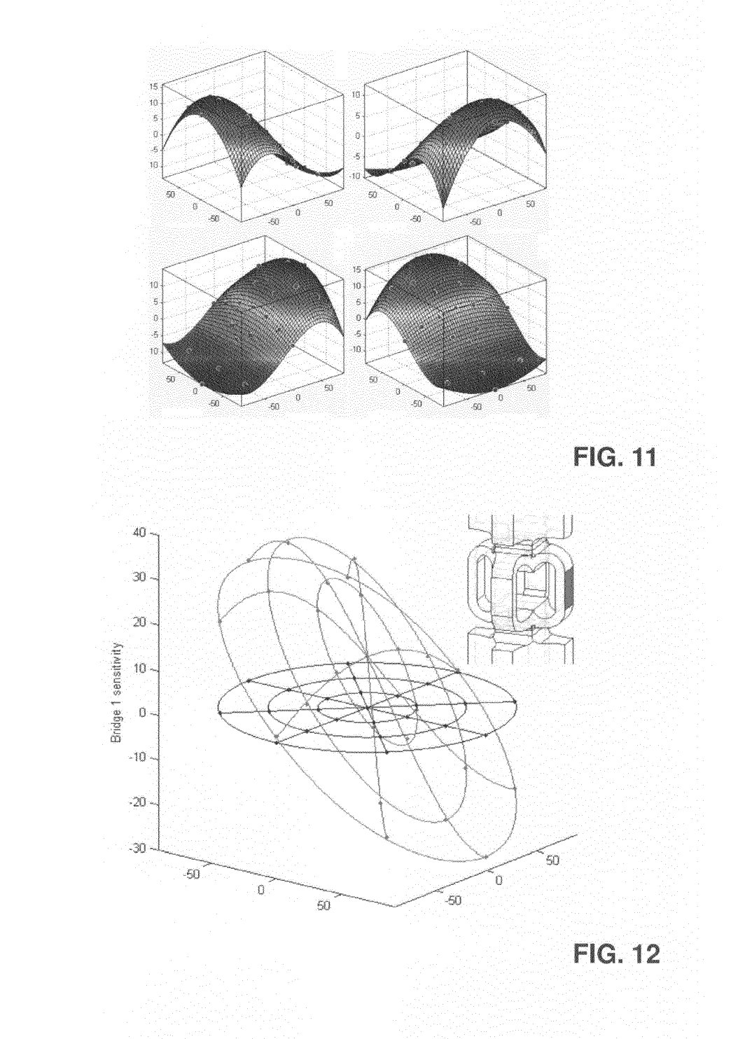

In order to demonstrate the angular distribution of the bridge outputs' responsiveness, a 3D parameter space has been defined the following way: the distance of the XY projection from the origin represents the angle of incidence, the value assigned to the x axis is given by the shear angle and z is the calculated slope. FIG. 11 presents the load orientation versus bridge output sensitivity in the introduced parameter space. It was found that 3rd order polynomial estimation of the surface span by the responsiveness values resulted in excellent accuracy. Due to manufacturing and gauge alignment imperfections the bridges exhibit different sensitivities. As a result of the symmetrical structure apart from a rotation the four bridge outputs are similar.

The more detailed direction dependent sensitivity of a bridge can be observed in FIG. 12.

One can see that the maximal sensitivity of the bridge is at θ=64°, Φ=180° with reference to the gauge plane orientation. In the θ=90°, Φ=90° and 270° directions the sensitivity is close to zero which is in close agreement with our model and the preliminary FEA results. The maximal sensitivity in the normal direction was found to be 11.57 mv/N, whereas for the shear x and y directions 26.54 mV/N and 25.78 mV/N, respectively. Considering the gain of the instrumentation amplifier and the resolution of the A/D stage the shear resolution is 5.41 mN and the normal resolution is 12.44 mN in the force range of 2.5 N.

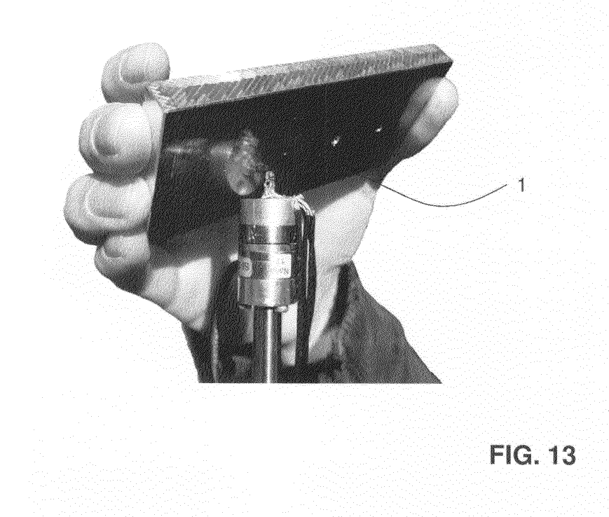

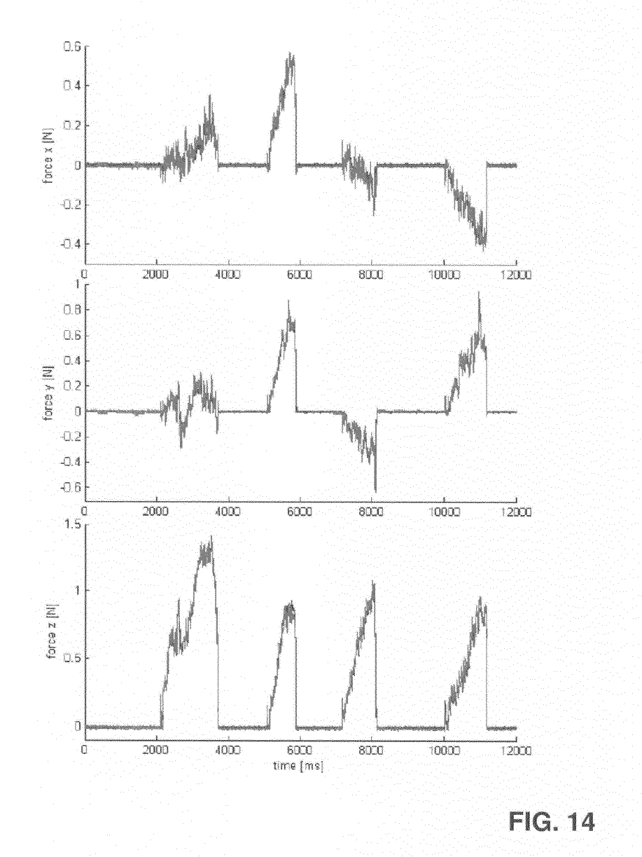

As a final evaluation step we mounted the calibrated sensor device 1 on top of the Nano 17 reference sensor 8 and made measurements in order to compare the signals. FIG. 13 shows the experimental setup, the results are presented in FIG. 14.

The RMS errors of the x, y and z force components were found to be 23 mN, 22.6 mN and 22.7 mN, respectively. It is important to emphasize that the misalignment between the investigated sensor and the Nano 17 also contributes to the error.

### CONCLUSION

A novel piezoresistive tri-axial force sensor device 1 has been developed that can be manufactured by conventional fabricating technologies. In spite of its miniature size the sensor's measurement performance is comparable to large size, commercial 6-DoF sensors (e.g. ATI Nano 17). The introduced calibration method allowed achieving angular and magnitudinal accuracy, which makes it possible to use the 3D force sensor 1 in any application in which both precision and small sensor size play a significant role.

An absolute resolution of 5.41 mN in shear direction and 12.44 mN in normal direction in the force range of 2.5 N is achieved. The full scale is scalable by modifying the sensor's dimensions and due to the robust monolithic structure the maximal load is restricted by the tensile strength of the strain gauges. The monolithic structure is preferably a one-piece structure. Integration of the sensor device 1 in minimally invasive surgical instruments is currently ongoing. In the future we intend to further reduce the size of the sensor, 2 mm diameter is achievable with the same fabrication process. In comparison with other sensors that employ the same principle, the herein described sensor device 1 is associated with uniform sensitivity and remarkable mechanical robustness.

Since the some focus was to develop and evaluate a miniature tri-axial force sensor that is capable of making measurements in surgical environment certain aspects of the sensing performance were favored to others. However, a duplicated structure consisting of two sensor bodies, i.e. two sensing elements 4 in a row, the sensing elements 4 comprising four at least three, preferably four arcs 40, can extend the sensing capability to 5 DoF, at the cost of increased sensor length and more complicated wiring. A possible solution to extend the measurement capability of the sensor is presented in FIG. 15.

### why Three Arcs are Needed to Measure a Force in 3D?

Assuming that we have a curved beam and the forces applied on it create pure bending a single arc 40 can measure only one force value. FIG. 16a demonstrates that one arc cannot distinguish between the vertical and horizontal forces. We can see that both Fₓ and F_{z} are creating the same strain (in red) on the arc and therefore this sensor cannot distinguish between the two force components. In order to separate between them we need an additional arc (see FIG. 16b). When relying on a symmetric geometry as shown on the Figure, the setup will not be sensitive to a force in the y direction. If we put the two arcs in an angle different from 180° one will still not be able to distinguish between F_{z} and F_{y} (both create a symmetric load on the two arcs). The solution is to use at least one more arc (see FIG. 16c).

A novel, robust, triaxial force sensor device 1 is provided that can be integrated into biomedical and robotic devices thanks to its size and accuracy. The monolithic sensor body is made of Titanium alloy and the components of the force are separated by four basic sensing elements. The sensor was modeled by finite element method and the results were validated by experimental data. The sensor diameter is 2.6 mm and height is 2 mm. Proper signal conditioning tools were realized in software and hardware to achieve a sensitivity of 26.54 mV/N and minimum detectable force of 5.41 mN. The sensing element's structure fits electrical discharge machining technologies. The sensor 1 was calibrated with a Nano 17 force sensor 8 and it was found that its performance is comparable to the commercial force sensor.

The proposed structure shows an increase in sensitivity and better homogeneity in all three directions.

### REFERENCES

[1] A. Krupa, G. Morel, and M. de Mathelin, “Achieving high precision laparoscopic manipulation through adaptive force control,” in Robotics and Automation, 2002. Proceedings. ICRA '02. IEEE International Conference on, 2002, pp. 1864-1869 vol. 2.
[2] R. Hoever, M. D. Luca, and M. Harders, “User-based evaluation of data-driven haptic rendering,” ACM Trans. Appl. Percept., vol. 8, pp. 1-23, 2010.
[3] S. Yu, S. N. Fry, D. P. Potasek, D. J. Bell, and B. J. Nelson, “Characterizing fruit fly flight behavior using a microforce sensor with a new comb-drive configuration,” Microelectromechanical Systems, Journal of, vol. 14, pp. 4-11, 2005.
[4] P. Puangmali, K. Althoefer, L. D. Seneviratne, D. Murphy, and P. Dasgupta, “State-of-the-Art in Force and Tactile Sensing for Minimally Invasive Surgery,” Sensors Journal, IEEE, vol. 8, pp. 371-381, 2008.
[5] P. Valdastri, K. Harada, A. Menciassi, L. Beccai, C. Stefanini, M. Fujie, and P. Dario, “Integration of a Miniaturised Triaxial Force Sensor in a Minimally Invasive Surgical Tool,” Biomedical Engineering, IEEE Transactions on, vol. 53, pp. 2397-2400, 2006.
[6] A. Uneri, M. A. Balicki, J. Handa, P. Gehlbach, R. H. Taylor, and I. Iordachita, “New steady-hand Eye Robot with micro-force sensing for vitreoretinal surgery,” in Biomedical Robotics and Biomechatronics (BioRob), 2010 3rd IEEE RAS and EMBS International Conference on, 2010, pp. 814-819.
[7] P. Valdastri, S. Roccella, L. Beccai, E. Cattin, A. Menciassi, M. C. Carrozza, and P. Dario, “Characterization of a novel hybrid silicon three axial force sensor,” Sensors and Actuators A: Physical, vol. 123-124, pp. 249-257, 2005.
[8] D. Benfield, E. Lou, and W. A. Moussa, “Parametric evaluation of shear sensitivity in piezoresistive interfacial force sensors,” Journal of Micromechanics and Microengineering, vol. 21, p. 045005, 2011.
[9] V. A. Ho, D. V. Dao, S. Sugiyama, and S. Hirai, “Design of a small-scale tactile sensor with three sensing points for using in robotic fingertips,” in Robotics and Automation (ICRA), 2010 IEEE International Conference on, 2010, pp. 4855-4860.
[10] Y. Hu, R. B. Katragadda, H. Tu, Q. Zheng, Y. Li, and Y. Xu, “Bioinspired 3-D Tactile Sensor for Minimally Invasive Surgery,” Microelectromechanical Systems, Journal of, vol. 19, pp. 1400-1408, 2010.
[11] K. Kristiansen, P. McGuiggan, G. Carver, C. Meinhart, and J. Israelachvili, “3D force and displacement sensor for SFA and AFM measurements,” Langmuir, vol. 24, pp. 1541-1549, February 2008.
[12] J. H. Shan, T. M. Mei, L. Sun, D. Y. Kong, Z. Y. Zhang, L. Ni., M. Meng, and J. R. Chu, “The design and fabrication of a flexible three-dimensional force sensor skin,” in Intelligent Robots and Systems, 2005. (IROS 2005). 2005 IEEE/RSJ International Conference on, 2005, pp. 18 18-1823.
[13] S. Spinner, J. Bartholomeyczik, B. Becker, M. Doelle, O. Paul, I. Polian, R. Roth, K. Seitz, and P. Ruther, Electromechanical reliability testing of three-axial silicon force sensors, 2006.
[14] G. Tholey and J. P. Desai, “A Modular, Automated Laparoscopic Grasper with Three-Dimensional Force Measurement Capability,” in Robotics and Automation, 2007 IEEE International Conference on, 2007, pp. 250-255.
[15] G. Vásárhelyi, M. Ádám, É. Vázsonyi, I. Bársony, and C. Dücsö, “Effects of the elastic cover on tactile sensor arrays,” Sensors and Actuators A: Physical, vol. 132, pp. 245-251, 2006.
[16] W. Wang, Y. Zhao, and Q. Lin, “An integrated MEMS tactile tri-axial micro-force probe sensor for Minimally Invasive Surgery,” in Nano/Molecular Medicine and Engineering (NANOMED), 2009 IEEE International Conference on, 2009, pp. 7 1-76.
[17] C.-C. Wen and W. Fang, “Tuning the sensing range and sensitivity of three axes tactile sensors using the polymer composite membrane,” Sensors and Actuators A: Physical, vol. 145-146, pp. 14-22, 2008.
[18] M. Ohka, Y. Mitsuya, I. Higashioka, and H. Kabeshita, “An experimental optical three-axis tactile sensor for micro-robots,” Robotica, vol. 23, pp. 457-465, July-August 2005.
[19] J. Peirs, J. Clijnen, D. Reynaerts, H. V. Brussel, P. Herijgers, B. Corteville, and S. Boone, “A micro optical force sensor for force feedback during minimally invasive robotic surgery,” Sensors and Actuators A: Physical, vol. 115, pp. 447-455, 2004.
[20] P. Polygerinos, P. Puangmali, T. Schaeffter, R. Razavi, L. D. Seneviratne, and K. Althoefer, “Novel miniature MRI-compatible fiber opticforce sensor for cardiac catheterization procedures,” in Robotics and Automation (ICRA), 2010 IEEE International Conference on, 2010, pp. 2598-2603.
[21] P. Puangmali, H. Liu, L. D. Seneviratne, P. Dasgupta, and K. Althoefer, “Miniature 3-Axis Distal Force Sensor for Minimally Invasive Surgical Palpation,” Mechatronics, IEEE/ASME Transactions on, vol. PP, pp. 1-11, 2011.
[22] U. X. Tan, Y. Bo, R. Gullapalli, and J. P. Desai, “Triaxial MRI-Compatible Fiber-optic Force Sensor,” Robotics, IEEE Transactions on, vol. 27, pp. 65-74, 2011.
[23] T. Tokuno, M. Tada, and K. Umeda, “High-precision MRI-compatible force sensor with parallel plate structure,” in Biomedical Robotics and Biomechatronics, 2008. BioRob 2008. 2nd IEEE RAS & EMBS International Conference on, 2008, pp. 33-38.
[24] F. Beyeler, S. Muntwyler, and B. J. Nelson, “A Six-Axis MEMS Force-Torque Sensor With Micro-Newton and Nano-Newtonmeter Resolution,” Microelectromechanical Systems, Journal of, vol. 18, pp. 433-441, 2009.
[25] H.-K. Lee, J. Chung, S.-I. Chang, and E. Yoon, “Normal and Shear Force Measurement Using a Flexible Polymer Tactile Sensor With Embedded Multiple Capacitors,” Microelectromechanical Systems, Journal of, vol. 17, pp. 934-942, 2008.
[26] U. Seibold, B. Kubler, and G. Hirzinger, “Prototype of Instrument for Minimally Invasive Surgery with 6-Axis Force Sensing Capability,” in Robotics and Automation, 2005. ICRA 2005. Proceedings of the 2005 IEEE International Conference on, 2005, pp. 496-501.
[27] P. Puangmali, P. Dasgupta, L. D. Seneviratne, and K. Althoefer, “Miniaturized triaxial optical fiber force sensor for MRI-Guided minimally invasive surgery,” in Robotics and Automation (ICRA), 2010 IEEE International Conference on, 2010, pp. 2592-2597.
[28] B. Levey, P. Gieschke, M. Doelle, S. Spinner, A. Trautmann, P. Ruther, O. Paul, and Ieee, “CMOS-integrated silicon 3D force sensor system for micro component coordinate measurement machines,” in Proceedings of the Ieee Twentieth Annual International Conference on Micro Electro Mechanical Systems, Vols 1 and 2, ed, 2007, pp. 486-489.

### LIST OF REFERENCE SIGNS

| | |
|---|---|
| 1 | Force sensor device |
| 2 | Tip |
| 3 | Base |
| 35 | Gap |
| 4 | Sensing element |
| 40 | Arc |
| 401 | First integrated sensing |
| | element/first strain gauge |
| 402 | Second integrated sensing |
| | element/second strain gauge |
| 403 | Additional third integrated |
| | sensing element/third strain |
| | gauge |
| 404 | Additional fourth integrated |
| | sensing element/fourth strain |
| | gauge |
| 41 | First beam or rod |
| 45 | Second beam or rod |
| 46 | Third beam or rod |
| 5 | Circuit board |
| 6 | PC |
| 7 | Calibration device |
| 71 | Frame |
| 72 | Sliding bar |
| 74 | Rotation plate |
| 75 | Base plate |
| 8 | Reference force sensor |
| C | Central axis |
| l_{sg} | Straight section |
| X, Y, Z | Directions |

1.-23. (canceled)

24. A force sensor device comprising at least three arcs distributed around a central axis, wherein the arcs have integrated sensing elements that measure strain applied on the arc resulting from a force applied on a central axis.

25. The force sensor device according to claim 24, wherein the arcs have at least two additional integrated sensing elements that are located on a position of the arc so that a torque applied orthogonal to the central axis causes a different strain on the additional integrated sensing elements than a force applied to an axis that would cause an identical strain as the torque on the integrated sensing elements.

26. The force sensor device according to claim 24, wherein at least two integrated sensing elements on any of the arcs are positioned at an angle relative to another pair of integrated sensing elements with respect to the central axis of rotation, so that a torque applied in parallel to the central axis would cause a different strain on those two integrated sensing elements than a force applied to the axis that would cause an identical strain as the torque on the other pair of integrated sensing elements around the axis.

27. The force sensor device according to claim 26, wherein the at least two elements are the additional integrated sensing elements.

28. The force sensor device according to claim 26, wherein the at least two elements are positioned at a 45° angle relative to the first set of integrated sensing elements.

29. The force sensor device according to claim 24, wherein the arcs are symmetrical with respect to the central axis and wherein the angular spacing between the arcs with respect to the central axis is equal.

30. The force sensor device according to claim 24, comprising at least or exactly four symmetrical arcs around the central axis.

31. The force sensor device according to claim 24, wherein the at least three arcs are attached to two rods above and below the arcs.

32. The force sensor device according to claim 24, wherein the force sensor is made as a monolithical structure.

33. The force/sensor device according to claim 32, wherein the force sensor is made of a Ti alloy, in particular of a Ti₆Al₄V alloy.

34. The force sensor device according to claim 33, wherein the force sensor is made of a polymer with strain sensing elements.

35. The force sensor device according to claim 24, wherein at least one, two, three, four or more of the integrated sensing elements are attached to an external surface of at least one or of each of the arcs.

36. The force sensor device according to claim 35, wherein the plurality of integrated sensing elements is provided on one arc, wherein said plurality of integrated sensing elements is attached to opposing external surfaces or to the same external surface of the respective arc.

37. The force sensor device according to claim 24, wherein the integrated sensing elements are piezoresistive or piezoelectric strain gauges.

38. The force sensor device according to claim 37, wherein said gauges are provided with a polymer layer for mechanical protection and electrical insulation.

39. The force sensor device according to claim 24, wherein the sensing elements are optical sensing elements.

40. The force sensor device according to claim 24, wherein the sensor device is a tri-axial force sensor device comprising a tip and a base, wherein said tip and said base are arranged in a spaced manner to one another along said central axis to form a gap therebetween, and wherein said gap is spanned by said arcs to connect said tip and said base to one another, wherein said arcs are bending arcs.

41. The force sensor device according to claim 40, wherein the arcs are joined in the middle of said gap such that each arc forms a double-C-shape.

42. The force sensor device according to claim 40, wherein a first free end of each arc extends into a first rod that is connected to the tip and a second free end of each arc extends in a C-shape into a second rod that is connected to the base.

43. The force sensor device according to claim 24, wherein a diameter of the force sensor device, in a direction transversely to the central axis, is substantially equal to or less than 3 mm, wherein lengths along the central axis of a tip and the arcs are substantially equal to or less than 3 mm, respectively.

44. The force sensor device according to claim 40, wherein each arc has a straight section, wherein two, three, four, or more lengthy integrated sensing elements are provided on at least one or on each arc.

45. The force sensor device according to claim 44, wherein said straight section extends parallel to the central axis.

46. The force sensor device according to claim 44, wherein the two or four lengthy integrated sensing elements on each arc are arranged in substantially crossed or angular manner with respect to one another.

47. The force sensor device according to claim 46, wherein at least two of the integrated sensing elements of the same arc are arranged on said arc, at a distance in direction of the central axis.

48. The force sensor device according to claim 47, wherein a first set of integrated sensing elements and a second set of integrated sensing elements are arranged at said distance, wherein the integrated sensing elements of the first and/or of the second set of integrated sensing elements are arranged, within the same set, in an angular manner with respect to one another.

49. The force sensor device according to claim 48, wherein the integrated sensing elements of the first and/or of the second set of integrated sensing elements are arranged, within the same set, substantially orthogonally to one another.

50. The force sensor device according to claim 48, wherein the integrated sensing elements of the first set are arranged at an angle with the central axis of substantially 0° and 90°, respectively, and wherein the integrated sensing elements of the second set are arranged at an angle of 30° to 60° or 45° to the central axis.

51. A method to measure forces in three dimensions comprising decomposing signals from integrated sensing elements of a force sensor device into three orthogonal elements that are directly related to a force vector applied on a central axis of arcs of the force sensor device, wherein the force sensor device comprises at least three arcs distributed around a central axis, wherein the arcs have integrated sensing elements that measure strain applied on the arcs, resulting from a force applied on the central axis.

52. A method to measure a combination of forces in three dimensions and torque in two dimensions comprising decomposing signals from integrated sensing elements of a force sensor device into three orthogonal elements of forces that are directly related to a force vector applied on a central axis and a torque vector applied orthogonal to the central axis of arcs of the force sensor device, whereas the torque vector is decomposed from the difference of signals of a first pair of integrated sensing elements and a corresponding second pair of integrated sensing elements, wherein the force sensor device comprises at least three arcs distributed around a central axis, wherein the arcs have integrated sensing elements that measure strain applied on the arcs, resulting from a force applied on the central axis, wherein the arcs have at least two additional integrated sensing elements that are located on a position of the arc so that a torque applied orthogonal to the central axis causes a different strain on that second set of the additional integrated sensing elements than a force applied to an axis that would cause an identical strain as the torque on the first set of integrated sensing elements.

53. A method to measure a combination of forces in three dimensions and torque in one dimension comprising decomposing signals from integrated sensing elements and additional integrated sensing elements according to claim 26 into three orthogonal elements of forces that are directly related to a force vector applied on the central axis and a torque applied parallel to the central axis of the arcs, whereas torque is decomposed from the difference of signals of first set of integrated sensing elements and a second set of integrated sensing elements, the second set of integrated sensing elements being positioned angular with respect to the first set along the central axis of rotation.

54. A calibration device for a force sensor device, the force sensor device comprising at least three arcs distributed around a central axis, wherein the arcs have integrated sensing elements that measure strain applied on the arc resulting from a force applied on the central axis, the calibration device comprising a base plate and a frame on the base plate, wherein said frame is rotatable about a yaw axis for setting a shear angle, wherein said frame is furthermore tiltable about a pitch axis for setting an angle of incidence, wherein the force sensor device is positioned in a way that the yaw and pitch axes intersect one another at the base of the force sensor device, and wherein a third, translational degree of freedom is implemented by a sliding bar.
